(19) United States
(12) Patent Application Publication
(10) Pub. No.: US 2004/0059996 A1
(43) Pub. Date: Mar. 25, 2004

(54) Exhibition of digital media assets from a digital media asset management system to facilitate creative story generation

(76) Inventor: Peter J. Fasciano, Natick, MA (US)

Correspondence Address: PETER J. GORDON, PATENT COUNSEL, AVID TECHNOLOGY, INC., ONE PARK WEST, TEWKSBURY, MA, 01876, US

(21) Appl. No.: 10/669,673

(22) Filed: Sep. 23, 2003

Related U.S. Application Data
(60) Provisional application No. 60/319,571, filed on Sep. 24, 2002.

(51) Int. Cl. G06F 17/21

(52) U.S. Cl. 715/500.1

(57) ABSTRACT

Digital media assets may be utilized more by exhibiting these assets to creative users in an enterprise. A system may randomly select the digital media assets to be exhibited. The exhibition of the assets may be a machine initiated task. The exhibition of digital media assets before a field of creative users across an enterprise, be they writers, directors, producers, etc., is intended to promote the spontaneous generation of new story ideas drawn from the random imagery. The exhibition of digital media assets may be performed in conjunction with a user interface that allows a storyline to be defined as a sequence of scenes. A currently exhibited digital media asset may be selected by a user for possible use in a selected scene. A user interface also may display results of comparing metadata associated with a scene and metadata associated with a currently exhibited digital media asset. The results of the comparison may include an indication of the relevance of a currently exhibited digital media asset to one or more scenes.

### CROSS-REFERENCE TO RELATED APPLICATIONS

This application is a non-provisional application that claims the benefit under 35 U.S.C. §119(e) of provisional patent application No. 60/319,571, filed on Sep. 24, 2002.

### BACKGROUND

Many large media libraries include media assets of significant value. Currently, most such libraries include primarily analog media, such as master tapes and film. More recently, media assets are being converted to digital form to better preserve them and potentially increase their value. Media assets may increase in value when in digital form because they become more accessible. Whether analog or digital, stored media assets normally sit dormant.

Digital media asset management systems, in general, require a large up-front investment to digitize the media assets and to organize the digital media assets in libraries. The potential for return on these digital media assets is often unknown. The ability to realize a return depends on, among other things, file sizes, accessibility, digital rights management, file formats and compatibility with other systems.

A significant barrier to realizing a return on a digital media asset management system is simply the ability to locate a useful digital media asset. Most digital media asset management tools require a query to identify digital media assets to be used. A variety of indexing techniques are in use. A user normally initiates a targeted search within a database to yield candidate digital media assets. The user then auditions the candidate digital media assets (often via visual or aural proxy) for their suitability for use within a specific scene, project or program idea. In some cases, a targeted search is defined according to the user, for example, based on a profile, search history, purchase history or other information related to the user. The candidate digital media assets often are presented to the user in an order according to some relevance rating defined by the search engine.

In addition to providing query access to a database, some owners of media asset libraries publish samples of their materials. For example, an owner of a video library may create and offer “demo reels” to provide a sampling of the kinds of material that are available. Media asset libraries on publicly accessible computer networks may provide sample images from such demo reels and/or may provide such demo reels in digital form.

Because the beauty and propriety of a media asset for a creative work, and hence the value of the media asset, lies in the eye of the beholder, it is difficult to provide an adequate indexing scheme for organizing media assets or to provide an adequate set of samples to illustrate the contents of a library. Thus, even under the best organizing principles and with the best demo reels, the most attractive media assets still may be static, untouched and essentially invisible to potential users.

### SUMMARY

Digital media assets may be utilized more by exhibiting these assets to creative users in an enterprise. A system may randomly select the digital media assets to be exhibited. The exhibition of the assets may be a machine initiated task. The exhibition of digital media assets before a field of creative users across an enterprise, be they writers, directors, producers, etc., is intended to promote the spontaneous generation of new story ideas drawn from the random imagery. The exhibition of digital media assets may be performed in conjunction with a user interface that allows a storyline to be defined as a sequence of scenes. A currently exhibited digital media asset may be selected by a user for possible use in a selected scene. A user interface also may display results of comparing metadata associated with a scene and metadata associated with a currently exhibited digital media asset. The results of the comparison may include an indication of the relevance of a currently exhibited digital media asset to one or more scenes.

### BRIEF DESCRIPTION OF THE DRAWINGS

FIG. 1 is block diagram of an example implementation of a system that exhibits digital media assets.

FIG. 2 is an illustration of a graphical user interface for creative story generation using a digital media asset management system.

### DETAILED DESCRIPTION

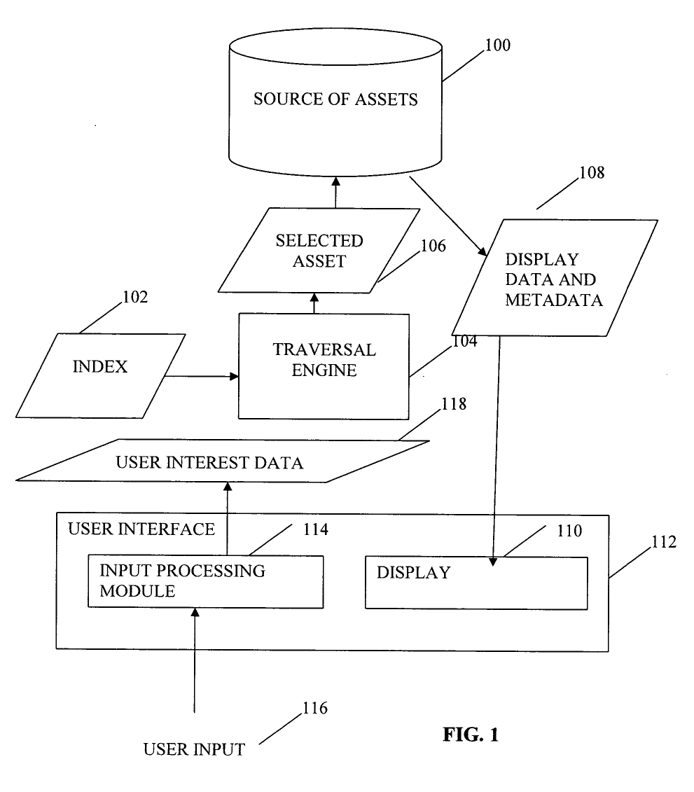

Referring to FIG. 1, a source 100 of digital media assets provides digital media assets that may be used in a creative work. Digital media assets include, but are not limited to, still images, including computer generated images, motion images, including computer generated animation, and audio. Various metadata about the digital media assets also may be stored. Such digital media assets typically are stored in data files in a computer file system.

An index 102 is provided to enable access to the digital media assets. The index may be implemented in many ways. Example implementations include but are not limited to a list (stored in memory or in a data file) of media files that are stored in a file system, a directory system in a file system, and a database system. The source 100 of digital media assets and index 102 may be implemented in one system, such as a database system.

A traversal engine 104 accesses the index 102 to select a digital media asset. An indication of the selected digital media asset 106 is used to access the media file for the digital media asset to cause corresponding display data 108 to be sent to one or more displays 110 in one or more user interfaces 112. The traversal engine 104 may direct the source 100 of digital media assets to send display data 108 to the displays 110. The traversal engine 104 also may receive the display data 108 from the source 100 first and then distribute the display data to the displays 110. If there are multiple users accessing the digital media assets, there may be one traversal engine 104 that presents the same digital media asset to all users on all displays 110, or each user system may use its own traversal engine 104, or a combination of such systems may be used.

The traversal engine 104 is designed to select from the digital media assets so as to expose media assets that might otherwise remain concealed if they are not searched for. Such active exhibition of digital media assets promotes awareness among potential users of the existence of these media assets and their suitability for use. Such exposition of media assets thus may promote creativity.

The traversal engine may perform such selection, for example, by randomly selecting digital media assets from one or more media asset libraries. “Randomly selecting” herein means any random or deterministic process (including any pseudorandom or quasi-random process) for selecting items from a set such that the selected items, when presented in a sequence, do not appear to be in an ordered sequence. This machine-directed traversal of the digital media assets, without direction from the user, injects spontaneity into the search for digital media assets to use in a creative work, thus enhancing the creativity of the editor.

As an example, the traversal engine may randomly select one digital media asset library from among several digital media asset libraries to retrieve one or more digital media assets from the selected library. The traversal engine may perform a query on one or more digital media asset libraries and present digital media assets from the result set of that query in a random order. For example, each digital media asset may have a randomly generated identifier. By presenting the digital media assets in order by their randomly generated identifier, the digital media assets will be presented in a random order. Also, the digital media assets in the result set from the query can be presented in the order they appear in the result set if the result set is unordered or unsorted by any parameter related to the digital media assets.

Such queries may be initiated in a number of ways, for example but not limited to, using key words supplied by the user, or using key words from a script or using other metadata associated with selected digital media assets. A query may be refined according to information from or about the user, such as indications of interest, lack of interest or other information about the digital media assets, so as to reduce the size of the result set from the query. Specific digital media assets in a result set also may be filtered from the result set so that they are not selected for display to the user.

Given a selected digital media asset, the display data 108 provided to the display 110 depends on the capabilities of the source 100 of digital media assets, the traversal engine 104 and the display 110, and the communication paths among them. If the digital media asset is a still image, then the display data may include, for example, the still image or a lower resolution proxy of that still image. For motion video data, the display data may include, for example, a still image representative of the scene, in either high or low resolution, a low-resolution proxy of the motion video data, or the full video data. A short sample of a long video clip also may be provided. For audio-only assets, the audio data appropriate for playback is sent along with display data that may be derived from other information related to the audio data. For long audio assets, a sample clip of the audio asset may be provided.

The information communicated to the user interface 112 also may include metadata about the digital media asset. Such metadata may include, for example but not limited to, keywords associated with the media asset, and relationship information about the media asset that may be derived from data formats such as the Open Media Framework (OMF) format, Advanced Authoring Format (AAF) and Material Exchange Format (MXF).

The display data may be presented in many ways. For example, the display data for a digital media asset may be presented as a singular, full screen still or motion image. As another example, a grid or checkerboard of images representing still images or clips may be displayed and serially updated, with each cell in the grid allowing playback of a clip. A clip also may be played back in a picture-in-picture format, along with a high-resolution still image from the clip.

The display data is used by the user interface 112 so as to exhibit the digital media assets. That is, the user interface 112 is periodically updated to display a new digital media asset. The update of the display is a machine-initiated task. The currently displayed digital media asset may be played in its entirety, for a limited amount of time, or after a user input is received. A user-modifiable setting may be provided to determine the duration of time for which a clip is played. When a grid display is used, the least recently displayed media asset may be removed from the grid, with the new digital media asset being added to the grid. After the digital media asset is displayed, the next digital media asset selected by the traversal engine is displayed. The exhibition of the digital media assets may be coordinated, for example but not limited to, by the user interface or by the traversal engine or through communication between them. Such exhibition of digital media assets may be, for example, a background task of computer systems that have access to a digital media asset management system within a creative enterprise.

Each user interface 112 also includes an input processing module 114 which processes user input 116. A user input is designated to be an indication from the user of the user's interest in the digital media asset that is currently displayed on the display 110. For example, the space bar on a keyboard may be so designated. The input processing module 114 thus creates user interest information 118 based on the user input. There is a variety of user interest information that may be collected. For example, a user may indicate a general, disassociated interest in a displayed digital media asset, for example by pressing the space bar on a keyboard. A user also may be prompted to input information about why there is an interest in the displayed media asset, or may be prompted to indicate where a reference to the digital media asset should be stored. This interest could be inferred from the location in which information about the displayed media asset ultimately is stored, or media works in which the displayed media asset ultimately is used.

The system also may allow the user to provide an input that indicates a lack of interest or perceived irrelevance in a displayed digital media asset. Such information regarding a lack of interest in an asset could be stored and used to filter the digital media assets being displayed to the user. Such filtering might include, for example, not exhibiting a digital media asset that is substantially similar to the digital media asset in which the user expressed a lack of interest.

This user interest information can be used in any of a number of ways to facilitate creative story generation. By allowing a user to mark and save links to or locations of interesting and desired digital media assets, selected materials may be used as the basis of other queries and suggestions. For example, the system may permit a query of the form “if you like this asset, then you might also like this other asset.” A timeline or storyboard or other timing tool may be provided to allow proxies of selected digital media assets to be organized into a narrative and allow the addition of text, audio, voice tracks, etc. Information about the digital media assets that have been identified on the client, called metadata, also may be used to search for further digital media assets and/or may be stored in a database to facilitate local searching of digital media assets at the client. Given a display of available media assets, other retrieval and organization tools may be provided to assist in story creation.

A simple implementation of such a system may be provided by modifying a so-called “slide show screen saver” computer program. In this implementation, a computer program receives as an input a directory in a file system and identifies all of the image files stored in that directory. The program, when executed, randomly selects and then displays the selected image files for a period of time, such as a few seconds. The random selection and display is repeated continuously. A user's input, such as pressing a space bar on a keyboard, provides an indication of the user's interest in the currently presented digital media asset. The file name of the currently displayed image then can be stored as the user interest information.

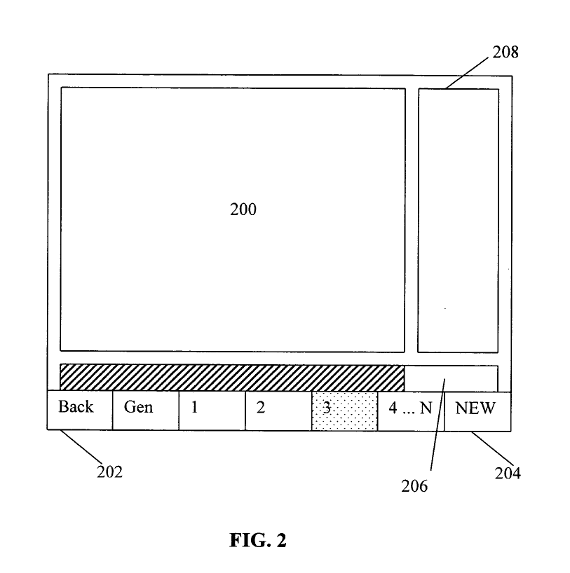

An example of the display of the user interface 112 in another embodiment will now be described in connection with FIG. 2. This example display includes a viewer area 200 in which display data related to a selected media asset, such as described above, is displayed. The display also includes a set of one or more “bins” or folders 202, shown in FIG. 2, by way of example only, at the bottom of the display. Each bin may have a displayed label to assist the user in identifying the contents of the bin. One bin may be designated as a general bin, labeled “Gen” in FIG. 2, and may be a default bin. A button 204, labeled “New” in FIG. 2, causes a new bin to be created when selected by the user. The bins created by the user, such as bins “1” through “N” in FIG. 2, may be reordered in the display, renamed, or deleted from the display. The order of these bins on the display may represent a story line for the story being created by the user. Alternatively, each bin may represent a story being created by the user, and the order of the contents in each bin may represent a story line for that story.

The display in FIG. 2 also may provide a relevance bar 206 that indicates the relevance of a displayed media asset in the viewer 200 to other digital media assets about which information has been stored in the bins. In particular, the relevance bar will indicate a score on a scale, e.g., on a scale of 1 to 10, indicating a measure of similarity between the currently displayed media asset and a selected bin (which may be highlighted, e.g., bin 3). If a displayed media asset is particularly relevant to a bin that is not selected, or if the most relevant bin is not the selected bin, then the relevant bin may be highlighted on the display, and the relevance score for that bin may be displayed by the relevance bar 206.

There are many ways to compute a relevance score between a displayed media asset and a bin. For example, key words may be associated with each digital media asset and/or each bin. The keywords associated with a displayed media asset can be compared to the keywords associated with a bin and/or the digital media assets it contains, using any of a number of similarity or difference metrics.

As noted above, the order of these bins on the display may represent a story line for the story being created by the user. Alternatively, each bin may represent a story being created by the user, and the order of the contents in each bin may represent a story line for that story. In either case, the contents of the bins may be imported into a nonlinear video editing system, using for example a timeline interface, to permit further editing of the story. A nonlinear video editing system that allows a clip to be represented using multiple sources, for example by using a drop down timeline as described in U.S. Pat. No. 6,161,115, may particularly benefit from using the contents of the storyline. In particular, each bin may be converted to a clip, with the contents of each bin defining the multiple sources for the clip. Alternatively, each digital media asset in a bin may be converted into a clip on the timeline of the nonlinear video editing system. Thus, the storyline provided by the bins 202 provide a rough cut of a program having that storyline.

The digital media assets in each bin also may be organized according to any of a number of principles. For example, a user may associate a value (indicating, for example, a score or rank) with each digital media asset to enable sorting of the digital media assets by that value. Digital media assets also may be ordered by time information.

The display of FIG. 2 also may include a dictionary, word list or thesaurus region 208. This area may display words and other information that are associated with a digital media asset. Keywords associated with a digital media asset may be inferred from its filename, and/or from its proximity to neighboring text or media assets in a multimedia composition or presentation or other associations with other media assets. For example, keywords for a digital media asset may be those words closest to the digital media asset in an HTML page or words associated with an image or a video, such as in an associated audio track or narrative. As another example, other information associated with the digital media asset may be derived from neighboring elements in a video sequence. User keyword associations may be expanded to automatically include common synonyms for keywords. If a user places the word “truck” into a search list then the thesaurus might also either automatically imply or overtly suggest the addition of “lorry,” “van,” “trailer” or other such words to such a query. Thus, a thesaurus may be coupled to a user terms list or dictionary of target words to further expand searches across synonyms either automatically or by user synonym selection to seek desired matching assets. Such associations may operate bilaterally. For example, when a user marks a preference for a given digital media asset that was randomly displayed there may be text or other associations to that digital media asset that could then populate the user dictionary to guide subsequent searching. The metadata associated with a digital media asset also may be assigned a weight by the user indicative of the user's perception of interest in or relevance of that metadata. This weighting could be used by thesaurus and/or the search engine to expand or limit a search.

The user interface also may store a history of displayed digital media assets. A user may access this history to view recently displayed digital media assets, for example by using the “Back” button shown in FIG. 2. The client may playback the digital media assets referenced by the history in the same manner as the originally displayed digital media assets are presented on the client, or in another format.

The various components of the system described herein may be implemented as a computer program using a general-purpose computer system. Such a computer system typically includes a main unit connected to both an output device that displays information to a user and an input device that receives input from a user. The main unit generally includes a processor connected to a memory system via an interconnection mechanism. The input device and output device also are connected to the processor and memory system via the interconnection mechanism.

One or more output devices may be connected to the computer system. Example output devices include, but are not limited to, a cathode ray tube (CRT) display, a liquid crystal display (LCD) and other video output devices, printers, communication devices such as a modem, and storage devices such as disk or tape. One or more input devices may be connected to the computer system. Example input devices include, but are not limited to, a keyboard, keypad, track ball, mouse, pen and tablet, communication device, and data input devices. The invention is not limited to the particular input or output devices used in combination with the computer system or to those described herein.

The computer system may be a general purpose computer system which is programmable using a computer programming language, such as “C++,” Visual Basic, JAVA or other language, such as a scripting language or even assembly language. The computer system may also be specially programmed, special purpose hardware. In a general-purpose computer system, the processor is typically a commercially available processor, such as various processors available from Intel, AMD, Cyrix, Motorola, and IBM. The general-purpose computer also typically has an operating system, which controls the execution of other computer programs and provides scheduling, debugging, input/output control, accounting, compilation, storage assignment, data management and memory management, and communication control and related services. Example operating systems include, but are not limited to, the UNIX operating system and those available from Microsoft and Apple Computer.

A memory system typically includes a computer readable medium. The medium may be volatile or nonvolatile, writeable or nonwriteable, and/or rewriteable or not rewriteable. A memory system stores data typically in binary form. Such data may define an application program to be executed by the microprocessor, or information stored on the disk to be processed by the application program. The invention is not limited to a particular memory system.

A system such as described herein may be implemented in software or hardware or firmware, or a combination of the three. The various elements of the system, either individually or in combination may be implemented as one or more computer program products in which computer program instructions are stored on a computer readable medium for execution by a computer. Various steps of a process may be performed by a computer executing such computer program instructions. The computer system may be a multiprocessor computer system or may include multiple computers connected over a computer network. The components shown in FIG. 1 may be separate modules of a computer program, or may be separate computer programs, which may be operable on separate computers. The data produced by these components may be stored in a memory system or transmitted between computer systems. As an example, the user interface may be executed on a client computer, whereas the traversal engine may be executed on a server computer. The traversal engine also may execute on a client computer to access a source of digital media assets and a corresponding index that may be residing on a server computer.

Having now described an example embodiment, it should be apparent to those skilled in the art that the foregoing is merely illustrative and not limiting, having been presented by way of example only. Numerous modifications and other embodiments are within the scope of one of ordinary skill in the art and are contemplated as falling within the scope of the invention.

What is claimed is:

1. A system for exhibiting stored digital media assets to one or more users, comprising:
means for traversing an index of the digital media assets to repeatedly select digital media assets without direction defined according to the user;
means for sequentially presenting the selected digital media assets to a client; and
means for storing information at the client regarding selected ones of the presented digital media assets.

2. The system of claim 1, wherein the means for storing includes means for permitting a user at the client to provide an input indicative of interest in a presented digital media asset.

3. The system of claim 2, wherein the means for storing further includes means for storing an indication of the source of the presented digital media asset at the client in a manner that allows retrieval of the presented digital media asset.

4. The system of claim 1, wherein the means for storing includes means for storing at the client a history describing recently presented digital media assets

5. The system of claim 4, wherein the client includes a means for manipulating the history to review the presented assets.

6. The system of claim 1, wherein the traversal is apparently random.

7. A system for exhibiting stored digital media assets to one or more users, comprising:
means for traversing an index of the digital media assets to repeatedly select digital media assets without direction defined according to the user;
means for sequentially presenting the selected digital media assets to a client; and
means for permitting a user at the client to provide an input indicative of interest in a presented digital media asset.

8. A computer-implemented method for facilitating definition of a storyline using stored digital media assets, comprising:
selecting digital media assets from among the stored digital media assets;
exhibiting the selected digital media assets to a user, whereby at least one of the exhibited selected digital media assets becomes a currently exhibited digital media asset;
receiving an input from the user indicative of the user's interest in the currently exhibited digital media asset; and
storing, as a sequence of scenes representing a storyline, information regarding the user's interest in the currently exhibited digital media asset, wherein the information includes at least an indication of the exhibited digital media asset.

9. The computer-implemented method of claim 8, wherein selecting comprises randomly selecting digital media assets from among the stored digital media assets.

10. The computer-implemented method of claim 8, wherein exhibiting comprises periodically initiating an update of a display, including displaying a digital media asset from among the selected digital media assets, wherein the displayed digital media asset is different from the currently exhibited digital media asset and, when displayed, becomes the currently exhibited digital media asset.

11. The computer-implemented method of claim 8, wherein the input indicative of the user's interest includes an input through a mechanical user interface of a computer.

12. The computer-implemented method of claim 8, wherein receiving the input occurs during exhibition of the currently exhibited digital media asset.

13. The computer-implemented method of claim 8 wherein the input further includes an indication of a reason for the user's interest in the currently exhibited digital media asset.

14. The computer-implemented method of claim 8, wherein the input comprises an indication of a lack of an interest in the currently exhibited digital media asset.

15. The computer-implemented method of claim 14, wherein the input further includes an indication of a reason for the lack of interest.

16. The computer-implemented method of claim 8, wherein each scene in the sequence of scenes is represented by a folder, and wherein storing comprises storing an indication of the currently exhibited digital media asset in the folder.

17. The computer-implemented method of claim 8, wherein a scene has associated metadata and the currently exhibited digital media asset has associated metadata, and wherein exhibiting comprises:
comparing the metadata of the scene with the metadata of the currently exhibited media asset; and
displaying to the user an indication of a result of the comparison.

18. A computer-implemented method for exhibiting stored digital media assets, comprising:
randomly selecting digital media assets from among the stored digital media assets;
exhibiting the selected digital media assets to a user, whereby at least one of the exhibited selected digital media assets becomes a currently exhibited digital media asset;
receiving an input from the user indicative of the user's interest in the currently exhibited digital media asset; and
storing information regarding the user's interest in the currently exhibited digital media asset, wherein the information includes at least an indication of the exhibited digital media asset.

19. The computer-implemented method of claim 18, wherein storing comprises:
storing a history describing recently exhibited digital media assets

20. The computer-implemented method of claim 19, further comprising:
receiving an input from the user for manipulating the history to review the previously exhibited digital media assets.

21. A computer-implemented method for facilitating definition of a sequence of scenes representing a storyline using digital media assets, wherein each scene has associated metadata, the method comprising:
exhibiting the digital media assets to a user, whereby at least one of the exhibited digital media assets becomes a currently exhibited digital media asset, wherein the currently exhibited digital media asset has associated metadata;
comparing the metadata of each scene with the metadata of the currently exhibited media asset; and
displaying to the user an indication of relevance of the currently exhibited digital media asset to at least one of the scenes according to a result of the comparison.

22. The computer implemented method of claim 21, further comprising:
receiving an input from a user indicative of the user's interest in the currently exhibited digital media asset;
storing information regarding the user's interest in the currently exhibited digital media asset, wherein the information includes at least an indication of the exhibited digital media asset.

23. The computer implemented method of claim 21, further comprising:
storing information regarding the currently exhibited digital media asset in association with at least one of the scenes.

24. The computer implemented method of claim 21, further comprising:
receiving an input from a user indicative of a scene with which the user wants to associate the currently exhibited digital media asset; and
storing information regarding the currently exhibited digital media asset in association with the indicated scene.

25. A computer program product, comprising:
a computer readable medium;
computer program instructions stored on the computer readable medium that, when processed by a computer, instructs the computer to perform a method for facilitating definition of a storyline using stored digital media assets, comprising:
selecting digital media assets from among the stored digital media assets;
exhibiting the selected digital media assets to a user, whereby at least one of the exhibited selected digital media assets becomes a currently exhibited digital media asset;
receiving an input from the user indicative of the user's interest in the currently exhibited digital media asset; and
storing, as a sequence of scenes representing a storyline, information regarding the user's interest in the currently exhibited digital media asset, wherein the information includes at least an indication of the exhibited digital media asset.

26. A computer program product, comprising:
a computer readable medium;
computer program instructions stored on the computer readable medium that, when processed by a computer, instructs the computer to perform a method for exhibiting stored digital media assets, comprising:
randomly selecting digital media assets from among the stored digital media assets;
exhibiting the selected digital media assets to a user, whereby at least one of the exhibited selected digital media assets becomes a currently exhibited digital media asset;
receiving an input from the user indicative of the user's interest in the currently exhibited digital media asset; and
storing information regarding the user's interest in the currently exhibited digital media asset, wherein the information includes at least an indication of the exhibited digital media asset.

27. A computer program product, comprising:
a computer readable medium;
computer program instructions stored on the computer readable medium that, when processed by a computer, instructs the computer to perform a method for facilitating definition of a sequence of scenes representing a storyline using digital media assets, wherein each scene has associated metadata, the method comprising:
exhibiting the digital media assets to a user, whereby at least one of the exhibited digital media assets becomes a currently exhibited digital media asset, wherein the currently exhibited digital media asset has associated metadata;
comparing the metadata of each scene with the metadata of the currently exhibited media asset; and
displaying to the user an indication of relevance of the currently exhibited digital media asset to at least one of the scenes according to a result of the comparison.
